(19) United States
(12) Patent Application Publication
(10) Pub. No.: US 2023/0349800 A1
(43) Pub. Date: Nov. 2, 2023

(54) AUTO-FLATTENING CONTROL ALGORITHM AND RELIABILITY TESTING METHOD OF SAMPLE USING SAME AND RELIABILITY TESTING DEVICE OF SAMPLE USING SAME

(71) Applicant: FlexiGO INC., Cheonan-si (KR)

(72) Inventors: Ki Yong LEE, Cheonan-si (KR); Tae Wan KIM, Cheonan-si, (KR); Yeon Woo JEONG, Cheonan-si (KR); Chang Suk O, Cheonan-si (KR)

(21) Appl. No.: 17/893,655

(22) Filed: Aug. 23, 2022

(30) Foreign Application Priority Data
Apr. 27, 2022 (KR) 10-2022-0052309

(51) Int. Cl. G01N 3/28; G01N 3/02

(52) U.S. Cl. CPC G01N 3/28; G01N 3/02; G01N 2203/0028; G01N 2203/0218

(57) ABSTRACT

Proposed is an auto-flattening control method that is an auto-flattening control method for determining a minimum driving value of tension that is applied to a sample coupled at both sides to a moving unit and a winding unit, respectively. The auto-flattening control method includes a sample rotation step of rotating the winding unit at a preset reference angle, a setup value checking step of monitoring a rotation load that is applied to a sample by rotation of the winding unit, and a setting comparison step of comparing variations between an N-th (a natural number larger than 0) rotation load and an N-1-th rotation load for the rotation load that is monitored through the setup value checking step.

### CROSS REFERENCE TO RELATED APPLICATION

The present application claims priority to Korean Patent Application No. 10-2022-0052309, filed Apr. 27, 2022, which is incorporated herein by reference in its entirety.

### BACKGROUND

### 1. Technical Field

The present disclosure relates to an auto-flattening control algorithm that keeps a sample such as a flexible material tensioned by maintaining tension, which is applied to the sample in rolling test of the sample, within a predetermined range, and reliability testing method and device of a sample using the auto-flattening control algorithm.

### 2. Description of the Related Art

In general, a Liquid Crystal Display (LCD), an Organic Light Emitting Diode (OLED), an electroluminescence (EL), etc., which are kinds of flat-panel displays (FPD), have low power consumption and are light and flat, so they are used in various fields including not only the monitors of a computer and a mobile phone, but vehicles and airplanes.

Recently, a flexible display having flexibility is being actively developed in this field. Such a flexible display, with improvement of the performance and quality, is required not only to be able to simply bend, but to have durability and driving stability against bending over a predetermined level. More accurately, such a flexible display has to be able to normally display images when it is bent or rolled and even when it is unrolled back. The flexible degree within the range in which a flexible display can normally display images, that is, flexibility is one of important performance of the flexible display.

Recently, as the performance and quality of a flexible display are developed, research about displays, such as a foldable display technology that can fully fold or unfold a display in use, a slidable display technology that can slide a display in use, and a rollable display technology that can roll a display like paper in use, is being actively conducted, and commercialization based on the results of the research is being also actively made.

In particular, when a durability test is performed on a rollable display in the process of developing the rollable display technology, tension that is applied to a sample is one of important factors that greatly influence the test. In order to derive a fair and consistent evaluation result of a test, tension that is applied to a sample should be consistently set.

However, since users set different tension for the same samples, there is a problem that when a rolling test is performed on samples the shapes of samples wound on a winding unit are different and considerable differences are caused in the durability evaluation of the samples.

### Documents of Related Art

### (Patent Document)

(Patent document 1) Korean Patent No. 10-2348742 (published on Jan. 7, 2022, title : Rolling device for durability evaluation of flexible material and evaluation system)

### SUMMARY

The present disclosure has been made in an effort to solve problems described above and an objective of the present disclosure is to provide an auto-flattening control algorithm that keeps a sample such as a flexible material tensioned by maintaining tension, which is applied to the sample in rolling test of the sample, within a predetermined range, and reliability testing method and device of a sample using the auto-flattening control algorithm.

Another objective of the present disclosure is to provide an auto-flattening control algorithm that enables a stable rolling test by optimally controlling tension, and reliability testing method and device of a sample using the auto-flattening control algorithm.

An auto-flattening control algorithm according to an embodiment of the present disclosure is an auto-flattening control algorithm for determining a minimum driving value of tension that is applied to a sample coupled at both sides to a moving unit and a winding unit, respectively. The auto-flattening control algorithm includes: a sample rotation step of rotating the winding unit at a preset reference angle or a preset examination angle; a setup value checking step of monitoring a rotation load that is applied to a sample by rotation of the winding unit; and a setting comparison step of comparing an N-th (a natural number larger than 0) rotation load and an N-1-th rotation load for the rotation load that is monitored through the setup value checking step, and further includes at least any one of: an examination rotation step of enabling the sample rotation step to be performed or of rotating the winding unit at the preset examination angle and then enabling the sample rotation step to be performed when the N-th rotation load is 0 or an N-th variation (a value obtained by subtract the N-1-th rotation load from the N-th rotation load) is 0 as the comparison result of the setting comparison step; and a minimum value setting step of calculating tension that is applied to a sample on the basis of an N-th rotation load when the N-th rotation load is larger than 0 or the N-th variation is larger than 0 as the result of the setting comparison step.

The examination rotation step may enable the sample rotation step to be performed when the N-th rotation load is 0 or the N-th variation (a value obtained by subtract the N-1-th rotation load from the N-th rotation load) is 0 as the comparison result of the setting comparison step, and may rotate the winding unit at the preset examination angle and then enable the setup value checking step to be performed when the N-th rotation load is larger than 0 or the N-th variation is larger than 0; and the minimum value calculation step may calculate tension that is applied to a sample on the basis of the N-1-th rotation load when the N-1-th rotation load is larger than 0 and the N-th rotation load is larger than 0 as the result of the setting comparison step.

A reliability test method of a sample according to an embodiment of the present disclosure is a method of testing reliability of a sample coupled at both sides to a moving unit and a winding unit, respectively, using a minimum driving value. The reliability test method includes: an initial value checking step of extracting a corresponding minimum driving value in accordance with the kind of a sample coupled to the moving unit and the winding unit; a start rotation step of applying tension to the sample in correspondence to the minimum driving value extracted through the initial value checking step and of rotating the winding unit at a preset start angle or a preset additional angle; a start value checking step of monitoring a rotation load that is applied to the sample by rotation of the winding unit; and a start comparison step of comparing the rotation load measured through the start value checking step with a preset limit load, and further includes at least any one of: an additional rotation step of enabling the start rotation step to be performed or rotating the winding unit at a preset additional angle and then enabling the start rotation step to be performed when a current rotation load is the preset limit load or less as the comparison result of the start comparison step; and a driving control step of controlling operation of the moving unit when the current rotation load exceeds the preset limit load as the comparison result of the start comparison step.

The start rotation step may be performed after the driving control step.

The minimum driving value may be determined as tension calculated through the minimum value calculation step in the auto-flattening control algorithm according to an embodiment of the present disclosure.

A reliability test device of a sample according to an embodiment of the present disclosure includes: a base unit; a winding unit being able to wind the sample thereon and rotatably coupled to the base unit; a moving unit to which an end of a sample wound on the winding unit is detachably coupled and that is slidably coupled to the base unit at a predetermined distance from the winding unit; and a control unit configured to control operation of the winding unit and the moving unit, in which the control unit includes at least any one of: a setting controller configured to determine a minimum driving value of tension that is applied to the sample; and an operation controller configured to integrally controlling rotation of the winding unit and slide of the moving unit on the basis of the minimum driving value of tension that is applied to the sample.

The setting controller may be implemented by the auto-flattening control algorithm according to an embodiment of the present disclosure and the operation controller may be implemented by the reliability test method of a sample according to an embodiment of the present disclosure.

According to the present disclosure, a sample such as a flexible material keeps tensioned by maintaining tension, which is applied to the sample in rolling test of the sample, within a predetermined range.

Further, it is possible to maintain uniformity of tension that is applied to a sample and enable a stable rolling test by optimally controlling tension.

Further, it is possible to improve precision in determination of a minimum driving value in accordance with the relationship between a preset reference angle and a preset examination angle.

Further, since the setup value checking step is performed after the examination rotation step, it is possible to implement continuity of the auto-flattening control algorithm for setting a minimum driving value.

Further, since the minimum value setting step is performed, it is possible to retain a minimum driving value in accordance with the kind of a sample, any user can simply set tension for a sample before performing a rolling test on the sample, and it is possible to provide a consistent setting value for a sample.

Further, it is possible to improve reliability of a rolling test of a sample through the reliability test method of a sample and it is possible to prevent deformation of or damage to a sample in a rolling test.

Further, it is possible to improve precision in a rolling test of a sample in accordance with the relationship of a preset start angle and a preset additional angle.

Further, since an initialization step is performed, it is possible to give tension to a sample set up in the test device as a minimum driving value and it is possible to quickly progress a rolling test.

Further, since the start value checking step is performed after the additional rotation step, it is possible to implement continuity for a rolling test.

Further, since the start rotation step or the additional rotation step is performed after the driving control step, it is possible to apply tension to a loosened sample F and it is possible to implemented continuity for a rolling test.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a view schematically showing a reliability testing device of a sample according to an embodiment of the present disclosure;

FIG. 2 is a flowchart showing an auto-flattening control algorithm according to an embodiment of the present disclosure; and

FIG. 3 is a flowchart schematically showing a reliability testing method of a sample according to an embodiment of the present disclosure.

### DETAILED DESCRIPTION

The above-mentioned objectives of the present disclosure, other objectives, features, and advantages would be easily understood through the following exemplary embodiments related to the accompanying drawings. However, the present disclosure is not limited to the embodiments described herein and may be implemented by other ways. On the contrary, the embodiments disclosed herein are provided so that the disclosed contents can be made through and complete and the spirit of the present disclosure can be sufficiently transmitted to those skilled in the art.

In this specification, when a component is on another component, the component may be formed directly on another component or a third component may be disposed therebetween. In the drawings, the thicknesses of components may be exaggerated for effective description.

When terms such as first, second, etc. are used to describe components in the specification, the components should not be limited by the terms. These terms are used only to discriminate some components from other components. Embodiments described herein include complementary embodiments.

When a first element (or component) is operated or executed on a second element (or component), it should be understood that the first element (or component) is operated or executed in an environment in which the second element (or component) is operated or executed or the second element (or component) is operated or executed directly or indirectly through interaction.

When an element, a component, a device, or a system include a component configured by a program or software, unless specifically stated, it should be understood that the element, component, device, or system includes hardware (e.g., a memory or a CPU), or another program, or software (e.g., an operating system a driver for driving hardware) that is required to execute or operate the program or software.

When an element (or component) is implemented, unless specifically stated, it should be understood that the element (or component) can be implemented in any type including software, hardware, or software and hardware.

The terms used herein are provided to describe embodiments without limiting the present disclosure. In the specification, a singular form includes a plural form unless specifically stated in the sentences. The terms “comprise” and/or “comprising” used herein do not exclude that another component exists or is added other than the stated component.

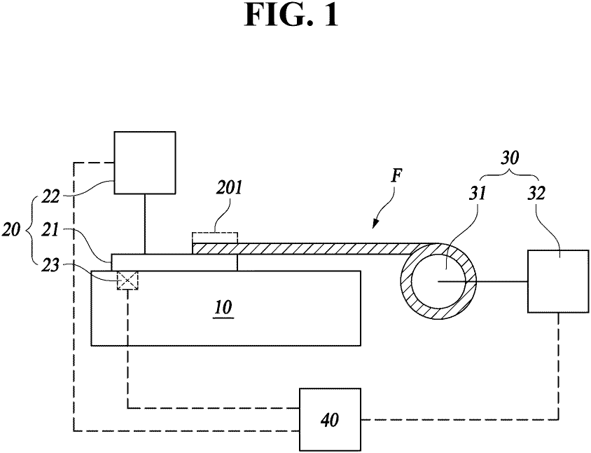

Referring to FIG. 1, a reliability testing method of a sample according to an embodiment of the present disclosure may include base unit 10, a winding unit 30 being able to wind a sample F and rotatably coupled to the base unit 10, a moving unit 20 to which an end of the sample F that is wound on the winding unit 30 is detachably coupled and is slidably coupled to the base unit 10 at a predetermined distance from the winding unit 30, and a control unit 40 controlling operation of the winding unit 30 and the moving unit 20.

The sample F according to an embodiment of the present disclosure may include a display panel made of a flexible material.

The base unit 10 forms the bottom of the test device. The winding unit 30 is rotatably coupled to the base unit 10 and moving unit is slidably coupled to the base unit 10 at a predetermined distance from the winding unit 30.

The winding unit 30 may include a winding member 31 that can wind the sample F detachably coupled thereto, and a winding driving member 32 rotating the winding member 31. The winding member 31 is rotatably coupled to the base unit 10. The winding driving member 32 can rotate the winding member 31 in a motor driving type.

The moving unit 20 may include a moving member 21 to which an end of the sample F is detachably coupled, and a moving driving member 22 sliding the moving member 21. The moving member 21 is slidably coupled to the base unit 10. The moving driving member 22 can slide the moving member 21 in a motor driving type.

The moving unit 20 may further include a load cell unit 23 that measures a load, which is applied to the moving member 21, in correspondence to tension that is applied to the sample F. The load cell unit 23 can measure a rotation load, which is applied to the sample F, in correspondence to sliding of the moving member 21.

The control unit 40 may include at least any one of a setting controller that determines a minimum driving value of tension that is applied to the sample F, and an operation controller that integrally controls rotation of the winding unit 30 and slide of the moving unit 20 on the basis of the minimum driving value of tension that is applied to the sample F.

The setting controller may include: a setting winder that controls operation of the winding driving member 32 such that the winding member 31 rotates at a preset reference angle or a preset examination angle with the sample F coupled; a setting checker that monitors a rotation load that is applied to the sample F by rotation of the winding member 31; and a setting comparer that compares an N-th (a natural number larger than 0) rotation load and an N-1-th rotation load for the rotation load that is monitored by the setting checker. The setting controller may further include at least any one of an examination rotator and a setting calculator, depending on the comparison result of the setting comparer.

The examination rotator is operated when the N-th rotation load is 0 or the N-th variation (a value obtained by subtract the N-1-th rotation load from the N-th rotation load) is 0 as the comparison result of the setting comparer. For example, the examination rotator may operate the setting winder. As another example, the examination rotator may rotate the winding member 31 of the winding unit 30 at a preset examination angle and then operate the setting checker. In this case, it is advantageous that the preset examination angle is the same as a preset reference angle.

The setting calculator is operated when the N-th rotation load is larger than 0 or the N-th variation is larger than 0 as the comparison result of the setting comparer. The setting calculator calculates tension that is applied to the sample F on the basis of the N-th rotation load.

Accordingly, as for the operation of the setting controller, assuming that the preset reference angle is 0.1 degrees, the preset examination angle is 0.1 degrees. When the load rotation that the setting checker secondarily monitored is 0 and the load rotation that the setting checker thirdly monitored is 8, the setting comparer operates the setting calculator. In this case, the setting calculator calculates tension that is applied to the sample of the basis of 8 that is the load rotation that the setting checker thirdly checks.

In the setting checker, a measurement value measured by the load cell unit 23 may be applied as a rotation load that is applied to the sample F by rotation of the winding member 31.

The setting controller may further include a setting setter that determines the tension calculated by the setting calculator as a minimum driving value that is applied to the winding member 31.

As a modification, the setting controller may further include at least any one of an examination rotator and a setting calculator. The examination rotator operates the setting winder when the N-th rotation load is 0 or the N-th variation (a value obtained by subtract the N-1-th rotation load from the N-th rotation load) is 0 as the comparison result of the setting comparer. The examination rotator rotates the winding member 31 of the winding unit 30 at a preset examination angle and then operates the setting checker when the N-th rotation load is larger than 0 or the N-th variation is larger than 0. In this case, it is advantageous that the preset examination angle is a preset reference angle or less.

When the N-1-th rotation load is larger than 0 and the N-th rotation load is larger than 0 as the comparison result of the setting comparer, the setting calculator calculates tension that is applied to the sample F on the basis of the N-1-th rotation load.

As for the operation of the setting controller according to a modification, it is assumed that the preset reference angle is 0.1 degrees and the preset examination angle is 0.01 degrees. Further, it is assumed that the rotation load of the sample F linearly increases per 0.1 degree.

When the load rotation that the setting checker secondarily monitored is 0 and the load rotation that the setting checker thirdly monitored is 8, the setting comparer operates the examination rotator. The examination rotator further rotates the winding member 31 by 0.01 degrees that is the preset examination angle.

Accordingly, as the winding member 31 is further rotated by 0.01 degrees, the sample F is further tensioned and the rotation load fourthly monitored by the setting checker increases by 1 more than the rotation load thirdly monitored by the setting checker, so the rotation load fourthly monitored by the setting checker becomes 9. Accordingly, the setting comparer operates the setting calculator.

For example, the setting calculator may calculate tension on the basis of 9 that is the rotation load thirdly monitored by the setting checker.

As another example, since the rotation load of the sample linearly increases per 0.1 degree, it can be seen that every time the winding member 31 rotates 0.1 degrees, the rotation load increases in increments of 10. Accordingly, the setting calculator may calculate tension on the basis of 8 that is the rotation load thirdly monitored, may calculate tension on the basis of 9 that is the rotation load fourthly monitored by the setting checker, may calculate tension on the basis of 10 that is the maximum rotation load per 0.1 degree, or may calculate tension on the basis of 5 that is a half of the maximum rotation load per 0.1 degree.

Although the operation of the setting controller was sequentially described in time series, the operation is not limited thereto and may show continuity.

The preset reference angle and the preset examination angle may be variously set in accordance with the test method.

The operation controller may include: a driving setter that extracts a corresponding minimum driving value in accordance with the kind of a sample F coupled to the moving unit 20 and the winding unit 30; a start winder that applies extension to a sample F in correspondence to the minimum driving value extracted by the driving setter and rotates the winding unit 30 at a preset start angle or a preset additional angle; a start checker that monitors a rotation load that is applied to a sample F by rotation of the winding member 31 of the winding unit 30; and a start comparer that compares the rotation load that is monitored by the start checker with a preset limit load. The operation controller may further include at least any one of an additional rotator and a diving controller, depending on the comparison result of the start comparer.

The additional rotator is operated when the current rotation load is a preset limit load or less as the comparison result of the start comparer. For example, the additional rotator may operate the start winder. As another example, the additional rotator may rotate the winding unit 30 at a preset additional angle and then operate the start checker.

The driving controller is operated when the current rotation load exceeds a preset limit load as the comparison result of the start comparer. The driving controller can control operation of the moving unit 20 such that tension applied to the sample F approaches a minimum driving value. The driving controller can control operation of the moving unit 20 and then operate the start winder.

Although the control operation of the operation controller was sequentially described in time series, the control operation is not limited thereto and may show continuity.

The preset start angle and the preset additional angle may be variously set in accordance with the test method.

The operation controller may further include an initial setter that sets a minimum driving value extracted by the driving setter in correspondence to a new sample F when the new sample F is coupled to the moving unit 20 and the winding unit in the reliability test device of a sample to test the sample F.

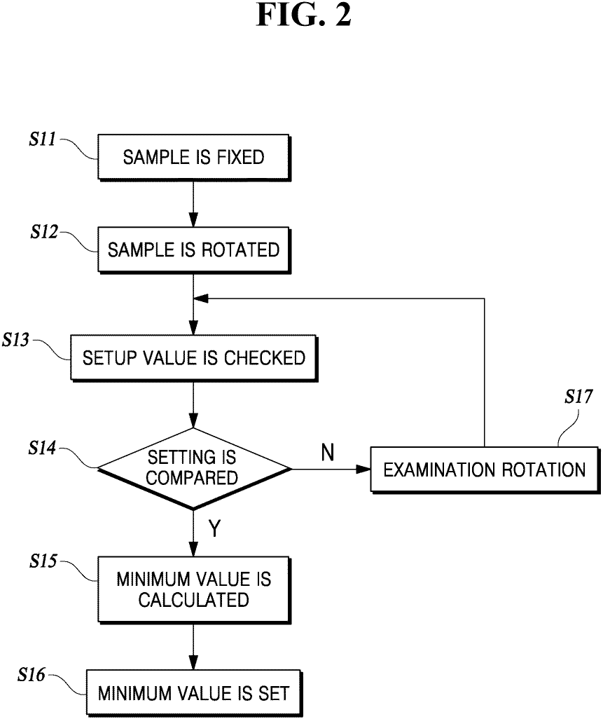

Referring to FIG. 2, the auto-flattening control algorithm according to an embodiment of the present disclosure is for determining a minimum driving value of tension that is applied to a sample F coupled at both sides to the moving unit 20 and the winding unit 30, respectively. The auto-flattening control algorithm according to an embodiment of the present disclosure can be implemented by the operation of the setting controller of the control unit 40.

The auto-flattening control algorithm according to an embodiment of the present disclosure may include a sample rotation step (S12), a setup value checking step (S13), and a setting comparison step (S14), and may further include at least any one of an examination rotation step (S17) and a minimum value calculation step (S15), and may further include a minimum value setting step (S16).

Before the sample rotation step (S12), a user may undergoes a sample fixing step (S11) in which both sides of a sample F is manually or automatically coupled to the moving member 21 of the moving unit 20 and the winding member 31 of the winding unit 30, respectively.

The sample rotation step (S12) rotates the winding member 31 of the winding unit 30 at a preset reference angle. The sample rotation step (S12) can be implemented by operation of the winding driving member 32 of the winding unit 30 according to operation of the setting winder.

The setup value checking step (S13) monitors a rotation load that is applied to a sample F by rotation of the winding unit 30. The setup value checking step (S13) can be implemented by monitoring a measurement value that is measured by the load cell unit 23 in accordance with operation of the setting checker.

The setting comparison step (S14) compares the N-th (a natural number larger than 0) rotation load and the N-1-th rotation load for the rotation load that is monitored through the setup value checking step (S13). The setting comparison step (S14) can be implemented by operation of the setting comparer.

The examination rotation step (S17) is performed when the N-th rotation load is 0 or the N-th variation (a value obtained by subtract the N-1-th rotation load from the N-th rotation load) is 0 as the comparison result of the setting comparison step (S14). For example, the examination rotation step (S17) may perform the sample rotation step (S12). As another example, the examination rotation step (S17) may rotate the winding member 31 of the winding unit 30 at a preset examination angle and then perform the sample rotation step (S12). The examination rotation step (S17) can be implemented by operation of the winding driving member 32 of the winding unit 30 according to operation of the examination rotator. Through the examination rotation step (S17), continuity of the auto-flattening control algorithm can be secured and continuous operation of the winding driving member 32 can be implemented.

The minimum value calculation step (S15) is performed when the N-th rotation load is larger than 0 or the N-th variation is larger than 0 as the comparison result of the setting comparison step (S14). The minimum value calculation step (S15) calculates tension that is applied to the sample F on the basis of the N-th rotation load. The minimum value calculation step (S15) can be implemented by operation of the setting calculator. After the minimum value calculation step (S15), the minimum value setting step (S16) is performed.

The minimum value setting step (S16) determines tension calculated through the minimum value calculation step (S15) as a minimum driving value that is applied to the winding member 31. The minimum value setting step (S16) can be implemented by operation of the setting setter. Through the minimum value setting step (S16), the auto-flattening control algorithm is finished.

As a modification, the examination rotation step (S17) and minimum value calculation step (S15) can be implemented by operation of the examination rotator and the setting calculator included in the setting controller according to a modification, respectively.

In more detail, for example, the examination rotation step (S17) enables the sample rotation step (S12) to be performed when the N-th rotation load is 0 or the N-th variation (a value obtained by subtract the N-1-th rotation load from the N-th rotation load) is 0 as the comparison result of the setting comparison step (S14). As another example, the examination rotation step (S17) rotates the winding member 31 of the winding unit 30 at a preset examination angle and then enables the setup value checking step (S13) to be performed when the -th rotation load is larger than 0 or the N-th variation is larger than 0.

When Nth rotation load is larger than 0 and the N-th rotation load is larger than 0 as the comparison result of the setting comparison step (S14), the minimum value setting step (S16) calculates tension that is applied to the sample F on the basis of the N-1-th rotation load.

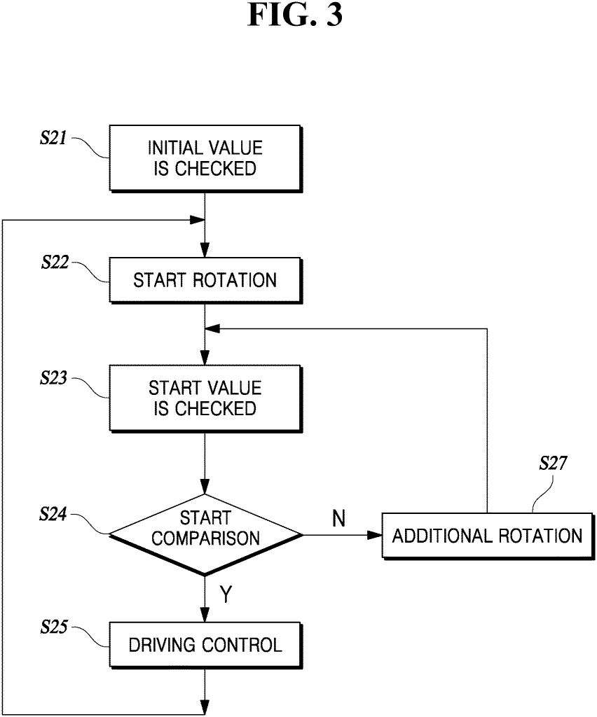

Referring to FIG. 3, the reliability testing method of a sample according to an embodiment of the present disclosure is a method of testing reliability of a sample F using a minimum driving value. The minimum driving value may be determined as tension calculated through the minimum value calculation step (S15) or the minimum value setting step (S16) in the auto-flattening control algorithm according to an embodiment of the present disclosure in accordance with the kind of the sample F. The reliability testing method of a sample according to an embodiment of the present disclosure can be implemented by the operation of the operation controller of the control unit 40.

The reliability testing method of a sample according to an embodiment of the present disclosure may include an initial value checking step (S21), a start rotation step (S22), a start value checking step (S23), and a start comparison step (S24), and may further include at least any one of an additional rotation step (S27) and a driving control step (S25).

The initial value checking step (S21) extracts a corresponding minimum driving value in accordance with the kind of a sample F coupled to the moving unit 20 and the winding unit 30. The initial value checking step (S21) can be implemented by operation of the driving setter.

The initial value checking step (S21) may further include an initial setting step that sets a minimum driving value extracted in the initial value checking step (S21) in correspondence to a new sample F when the new sample F is coupled to the moving unit 20 and the winding unit in the reliability test device of a sample to test the sample F. The initial setting step can be implemented by operation of the initial setter.

The start rotation step (S22) applies tension to a sample F in correspondence to the minimum driving value extracted through the initial value checking step (S21) and rotates the winding unit 30 at a preset start angle or a preset additional angle. The start rotation step (S22) can be implemented by operation of the winding driving member 32 of the winding unit 30 according to operation of the start winder.

The start value checking step (S23) monitors a rotation load that is applied to a sample F by rotation of the winding member 31 of the winding unit 30. The start value checking step (S23) can be implemented by monitoring a measurement value that is measured by the load cell unit 23 in accordance with operation of the start checker.

The start comparison step (S24) compares the rotation load measured through the start value checking step (S23) with a preset limit load. The start comparison step (S24) can be implemented by operation of the driving setter.

The additional rotation step (S27) is performed when the current rotation load is a preset limit load or less as the comparison result of the start comparison step (S24). The additional rotation step (S27) can be implemented by operation of the winding driving member 32 of the winding unit 30 according to operation of the additional rotator. For example, the additional rotation step (S27) enables the start rotation step (S22) to be performed. As another example, the additional rotation step (S27) rotates the winding member 31 of the winding unit 30 at a preset additional angle and then enables the start rotation step (S22) to be performed, so it is possible to secure continuity of the reliability test method of a sample F and implement continuous operation of the winding driving member 32.

The driving control step (S25) is performed when the current rotation load exceeds a preset limit load as the comparison result of the start comparison step (S24). The driving control step (S25) may be implemented by operation of the moving unit 20 and the moving driving member 22 according to operation of the driving controller. The driving control step (S25) controls operation of the moving unit 20 such that tension applied to the sample F approaches a minimum driving value. After the driving control step (S25), the start rotation step (S22) is performed, so it is possible to secure continuity of the reliability test method of a sample F and implement continuous operation of the winding driving member 32, and a sample F can be continuously wound on the winding member 31.

According to the present disclosure, a sample F such as a flexible material keeps tensioned by maintaining tension, which is applied to the sample in rolling test of the sample F, within a predetermined range.

Further, it is possible to maintain uniformity of tension that is applied to a sample F and enable a stable rolling test by optimally controlling tension.

Further, it is possible to improve precision in determination of a minimum driving value in accordance with the relationship between a preset reference angle and a preset examination angle.

Further, since the setup value checking step (S13) is performed after the examination rotation step (S17), it is possible to implement continuity of the auto-flattening control algorithm for setting a minimum driving value.

Further, since the minimum value setting step (S16) is performed, it is possible to retain a minimum driving value in accordance with the kind of a sample F, any user can simply set tension for a sample F before performing a rolling test on the sample, and it is possible to provide a consistent setting value for a sample F.

Further, it is possible to improve reliability of a rolling test of a sample F through the reliability test method of a sample F and it is possible to prevent deformation of or damage to a sample F in a rolling test.

Further, it is possible to improve precision in a rolling test of a sample F in accordance with the relationship of a preset start angle and a preset additional angle.

Further, since an initialization step is performed, it is possible to apply tension to a sample F set up in the test device as a minimum driving value and it is possible to quickly progress a rolling test.

Further, since the start value checking step (S23) is performed after the additional rotation step (S27), it is possible to implement continuity for a rolling test.

Further, since the start rotation step (S22) or the additional rotation step (S27) is performed after the driving control step (S25), it is possible to apply tension to a loosened sample F and it is possible to implemented continuity for a rolling test.

What is claimed is:

1. An auto-flattening control method for determining a minimum driving value of tension that is applied to a sample coupled at both sides to a moving unit and a winding unit, respectively, the auto-flattening control method comprising:
a sample rotation step of rotating the winding unit at a preset reference angle or a preset examination angle;
a setup value checking step of monitoring a rotation load that is applied to a sample by rotation of the winding unit; and
a setting comparison step of comparing an N-th (a natural number larger than 0) rotation load and an N-1-th rotation load for the rotation load that is monitored through the setup value checking step,
wherein the method further comprises at least any one of:
an examination rotation step of enabling the sample rotation step to be performed or of rotating the winding unit at the preset examination angle and then enabling the sample rotation step to be performed when the N-th rotation load is 0 or an N-th variation (a value obtained by subtract the N-1-th rotation load from the N-th rotation load) is 0 as the comparison result of the setting comparison step; or
a minimum value calculation step of calculating tension that is applied to a sample on the basis of an N-th rotation load when the N-th rotation load is larger than 0 or the N-th variation is larger than 0 as the result of the setting comparison step.

2. The auto-flattening control method of claim 1, wherein the examination rotation step enables the sample rotation step to be performed when the N-th rotation load is 0 or the N-th variation (a value obtained by subtract the N-1-th rotation load from the N-th rotation load) is 0 as the comparison result of the setting comparison step, and rotates the winding unit at the preset examination angle and then enables the setup value checking step to be performed when the N-th rotation load is larger than 0 or the N-th variation is larger than 0, and
wherein the minimum value calculation step calculates tension that is applied to a sample on the basis of the N-1-th rotation load when the N-1-th rotation load is larger than 0 and the N-th rotation load is larger than 0 as the result of the setting comparison step.

3. A reliability test method of a sample for testing reliability of a sample coupled at both sides to a moving unit and a winding unit, respectively, using a minimum driving value, the reliability test method comprising:
an initial value checking step of extracting a corresponding minimum driving value in accordance with the kind of a sample coupled to the moving unit and the winding unit;
a start rotation step of applying tension to the sample in correspondence to the minimum driving value extracted through the initial value checking step and of rotating the winding unit at a preset start angle or a preset additional angle;
a start value checking step of monitoring a rotation load that is applied to the sample by rotation of the winding unit; and
a start comparison step of comparing the rotation load measured through the start value checking step with a preset limit load,
wherein the method further comprises at least any one of:
an additional rotation step of enabling the start rotation step to be performed or rotating the winding unit at a preset additional angle and then enabling the start rotation step to be performed when a current rotation load is the preset limit load or less as the comparison result of the start comparison step; or
a driving control step of controlling operation of the moving unit when the current rotation load exceeds the preset limit load as the comparison result of the start comparison step.

4. The reliability test method of claim 3, wherein the start rotation step is performed after the driving control step.

5. The reliability test method of claim 3, wherein the minimum driving value is determined as tension calculated by:
a sample rotation step of rotating the winding unit at a preset reference angle or a preset examination angle;
a setup value checking step of monitoring a rotation load that is applied to a sample by rotation of the winding unit; and
a setting comparison step of comparing an N-th (a natural number larger than 0) rotation load and an N-1-th rotation load for the rotation load that is monitored through the setup value checking step, and
a minimum value calculation step of calculating the tension that is applied to a sample on the basis of an N-th rotation load when the N-th rotation load is larger than 0 or the N-th variation is larger than 0 as the result of the setting comparison step.

6. The reliability test method of claim 4, wherein the minimum driving value is determined as tension calculated by:
a sample rotation step of rotating the winding unit at a preset reference angle or a preset examination angle;
a setup value checking step of monitoring a rotation load that is applied to a sample by rotation of the winding unit; and
a setting comparison step of comparing an N-th (a natural number larger than 0) rotation load and an N-1-th rotation load for the rotation load that is monitored through the setup value checking step, and
a minimum value calculation step of calculating the tension that is applied to a sample on the basis of an N-th rotation load when the N-th rotation load is larger than 0 or the N-th variation is larger than 0 as the result of the setting comparison step.

7. A reliability test device of a sample, comprising:
a base unit;
a winding unit being able to wind the sample thereon and rotatably coupled to the base unit;
a moving unit to which an end of a sample wound on the winding unit is detachably coupled and that is slidably coupled to the base unit at a predetermined distance from the winding unit; and
a control unit configured to control operation of the winding unit and the moving unit,
wherein the control unit comprises at least any one of:
a setting controller configured to determine a minimum driving value of tension that is applied to the sample; or
an operation controller configured to integrally controlling rotation of the winding unit and slide of the moving unit on the basis of the minimum driving value of tension that is applied to the sample.
